(19) United States
(12) Patent Application Publication
(10) Pub. No.: US 2005/0183531 A1
(43) Pub. Date: Aug. 25, 2005

(54) Gear

(75) Inventors: Toru Hagihara, Sayama-shi (JP); Toru Takumori, Saitama-shi (JP)

Correspondence Address: BACHMAN & LAPOINTE, P.C., 900 CHAPEL STREET, SUITE 1201, NEW HAVEN, CT, 06510, US

(73) Assignee: Enplas Corporation

(21) Appl. No.: 11/064,582

(22) Filed: Feb. 23, 2005

(30) Foreign Application Priority Data
Feb. 24, 2004 (JP) 2004-048279

(51) Int. Cl. F16H 55/18

(52) U.S. Cl. 74/440

(57) ABSTRACT

In a gear having teeth 2 on the outer periphery thereof, each of the teeth 2 has an elastically deformable overhanging portion 7 which is formed on one end face 6 in facewidth directions of a corresponding one of the teeth 2 so as to protrude from a portion near a tooth flank 8 of the corresponding one of the teeth 2 toward adjacent one of the teeth 2, and a portion of the overhanging portion 7 contacting one of teeth of a companion gear is formed so as to have the same plane as that of the tooth flank 8 when the overhanging portion 7 is pressed by the one of teeth of the companion gear to be elastically deformed.

### BACKGROUND OF THE INVENTION

1. Field of the Invention

The present invention relates to a gear capable of reducing noises and vibrations during transmission of rotation.

2. Description of the Background Art

In recent years, for example, a typical ink jet printer used on a desk side uses many gears in the driving mechanism of the printing portion thereof and in the paper feed mechanism thereof to transmit rotation of motors to driven parts via the gears. In such an ink jet printer, the driving mechanism of the printing portion and the paper feed mechanism are designed to frequently repeat rotation and stopping, so that there are some cases where one of a pair of teeth meshing with each other during stopping and starting may collide with the other tooth due to inertia to produce teeth knocking noises and noises due to vibrations or the like. However, in order to provide a good office environment, the above described ink jet printer used on the desk side is required to reduce operation noises to operate as quiet as possible. Therefore, various gears designed to reduce operation noises during power transmission have been proposed.

As a first conventional example, a gear 50 shown in FIGS. 13A and 13B has fillet portions 52, which are formed on both tooth flanks on one end side in facewidth directions of each tooth 51 and which are designed to contact a companion gear meshing with the gear 50 to be deformed to absorb shocks when the gear 50 meshes with the companion gear (see Japanese Utility Model Laid-Open No. 55-100745).

As a second conventional example, a gear 53 shown in FIGS. 14A and 14B has slits 56, each of which is formed on the side of a tooth flank 55 meshing with a companion gear 54 so as to extend along the tooth flank 55 and so as to pass through each tooth in facewidth directions, and each of which allows the tooth flank 55 meshing with the companion gear 54 to be elastically deformed to absorb shocks when the tooth flank 55 meshes with the companion gear 54 (see Japanese Utility Model Laid-Open No. 58-127246).

As a third conventional example, a gear 57 shown in FIG. 15 has through holes 60, each of which passes through each tooth 58 in facewidth directions, and each of which allows the whole tooth 58 to be easily elastically deformed to absorb shocks when the gear 57 meshes with a companion gear (see Japanese Utility Model Laid-Open No. 55-98849).

As a fourth conventional example, a gear 61 shown in FIG. 16 has slits 63, each of which is formed in each tooth 62 so as to extend in facewidth directions over the entire facewidth and so as to extend from a tooth crest 64 to pass through a bottom land 65, and each of which allows the tooth 62 to be easily elastically deformed to absorb shocks when the gear 61 meshes with a companion gear (see Japanese Utility Model Laid-Open No. 55-98850).

As a fifth conventional example, a gear 66 shown in FIG. 17 has visco-elastic bodies 70, each of which protrudes from both tooth flanks 68 of each tooth 67 in a central portion in facewidth directions, and each of which is designed to contact a tooth flank of a companion gear to absorb shocks when the gear 66 meshes with the companion gear (see Japanese Patent Laid-Open No. 2001-221322).

As a sixth conventional example, a gear 71 shown in FIG. 18 and proposed by the inventors of the present application has cavity portions 73 which are formed in both end portions in facewidth directions of each tooth 72, and elastically deformable swelling portions 74 which are formed on both end portions in facewidth directions of each tooth 72 by the difference in shrinkage after injection molding between both end portions having the cavity portions 73 in facewidth directions and other portions, the swelling portions 74 being designed to be elastically deformed to absorb shocks when the gear 71 meshes with a companion gear (see Japanese Patent Laid-Open No. 2003-90412).

However, in the first conventional example, the fillet portions 52 are formed on only one end side in facewidth directions, and thin walled portions and cavity portions capable of absorbing deformation of the fillet portions 52 are not formed. Therefore, the surface pressure applied on the fillet portions 52 is too large, so that the fillet portions 52 are early worn. Thus, there is the possibility that, when the gear meshes with a companion gear, it is not possible to obtain shock absorbing effects for a long period of time, so that it is not possible to stably obtain teeth knocking noise absorbing effects for a long period of time.

In the second conventional example, since the tooth flank 55 meshing with a companion gear during power transmission is elastically deformed over the whole region in facewidth directions, the amount of elastic deformation varies in accordance with load during power transmission, so that the angle of rotation per tooth is easy to vary. Therefore, it is difficult for the gear 53 to be used for a gear train for precisely transmitting rotation.

In the third and fourth conventional examples, since the whole teeth 58 and 62 are easily deformed, the amount of elastic deformation of the teeth 58 and 62 varies in accordance with load during power transmission similar to the second conventional example, so that the angle of rotation per tooth is easy to vary. Therefore, it is difficult for the gears 57 and 61 to be used for a gear train for precisely transmitting rotation.

In the fifth conventional example, although the visco-elastic bodies 70 protruding from the tooth flanks 68 are compressed to be deformed by load during power transmission, the amount of deformation thereof varies in accordance with the load during power transmission. Therefore, similar to the second through fourth conventional examples, it is difficult for the gear 66 to be used for a gear train for precisely transmitting rotation.

In the sixth conventional example, if the swelling portions 74 are elastically deformed, the tooth flank 75 except for the swelling portions 74 contacts the tooth flank of a companion gear to transmit power. Therefore, it is possible to more precisely transmit rotation than the gear in the second through fifth conventional examples. In addition, since the swelling portions 74 are formed on both end portions in facewidth directions, it is possible to decrease the surface pressure when the gear 71 meshes with the companion gear, and it is difficult to cause the early wearing of the teeth 72 unlike the first conventional example. However, since the swelling portions 74 are formed on the basis of the difference in shrinkage after injection molding, the swelling amount is small, so that it is not possible to cause the swelling portions 74 to greatly protrude from the tooth flanks 75 to such an extent that it is possible to sufficiently absorb backlash.

As a gear for eliminating the problems in the above described first through sixth conventional examples, the inventors of the present application have proposed a gear 81 shown in FIG. 19, which has elastically deformable overhanging portions 84, each of which protrudes from one of tooth flanks 83 of each tooth 82 toward an adjacent tooth 82 to absorb backlash to reduce teeth knocking noises and vibration noises (Japanese Patent Application No. 2004-22765).

In comparison with the above described first through sixth conventional examples, the gear 81 can reduce teeth knocking noises due to backlash when the gear 81 meshes a companion gear, and can reduce operation noises in an intermittent rotation transmission mechanism for repeating rotation and stopping. However, many ink jet printers using the gear 81 are designed to reversely rotate the driving shaft of a printing portion for cleaning, so that it is required to reduce operation noises during reverse rotation.

### SUMMARY OF THE INVENTION

It is therefore an object of the present invention to provide a gear capable of reducing operation noise during reverse rotation while eliminating the aforementioned problem in the first through sixth conventional examples.

In order to accomplish the aforementioned and other objects, according to one aspect of the present invention, there is provided a gear having teeth on an outer periphery thereof, wherein each of the teeth has an elastically deformable overhanging portion which is formed on at least one of end faces in facewidth directions of a corresponding one of the teeth so as to protrude from a portion near one of tooth flanks of the corresponding one of the teeth toward adjacent one of the teeth, and wherein a portion of the overhanging portion contacting one of teeth of a companion gear is formed so as to have the same plane as that of the one of tooth flanks when the overhanging portion is pressed by the one of teeth of the companion gear to be elastically deformed.

In this gear, the overhanging portion may be a substantially plate-shaped protruding piece, and the overhanging portion may have a root portion which is arranged on the one of end faces so as to be retracted from the one of tooth flanks, the overhanging portion substantially extending along the one of tooth flanks, and an inner end of the overhanging portion in radial directions being arranged inside of a bottom land of the corresponding one of the teeth in radial directions. The inner end of the overhanging portion may be connected to an annular protruding portion which is formed on the one of end faces. The outer end of the overhanging portion in radial directions may be arranged so as to be spaced by a predetermined distance from a tooth crest of the corresponding one of the teeth toward the bottom land. The overhanging portion may be formed so that the outer end of the overhanging portion in radial directions is inclined from the root portion toward a tip portion thereof.

If a gear according to the present invention is used for a gear train designed to repeat rotation and stopping, when a pair of teeth meshing with each other are moved by backlash to contact each other, an overhanging portion elastically contacts the tooth flank of a corresponding one of teeth of a companion gear meshing with the gear to fulfill a damping function, so that it is possible to suppress the production of teeth knocking noises and noises due to vibrations. The overhanging portion of the gear according to the present invention may be a substantially plate-shaped protruding piece, and the root portion of the overhanging portion may be formed on the end face in facewidth directions so as to be retracted from the tooth flank. In addition, during transmission of rotation, the portion of the overhanging portion contacting the corresponding one of teeth of the companion gear may have the same plane as that of the companion gear. Therefore, the contact pressure applied to the overhanging portion is not excessive, so that it is also possible to reduce operation noises during transmission of reverse rotation.

### BRIEF DESCRIPTION OF THE DRAWINGS

The present invention will be understood more fully from the detailed description given herebelow and from the accompanying drawings of the preferred embodiments of the invention. However, the drawings are not intended to imply limitation of the invention to a specific embodiment, but are for explanation and understanding only.

In the drawings:

FIG. 1 is a front view of the first preferred embodiment of a gear according to the present invention;

FIG. 2 is a sectional view taken along line II-II of FIG. 1;

FIG. 3 is a plan view of a tooth of the gear of FIG. 1, which is viewed in a direction of allow A of FIG. 2;

FIG. 4A is an enlarged front view of part of the gear of FIG. 1;

FIG. 4B is a sectional view taken along line IVB-IVB of FIG. 4A;

FIG. 4C is a sectional view taken along line IVC-IVC of FIG. 4A;

FIG. 5 is a graph showing noise values when a gear in this preferred embodiment is used for a driving mechanism of a printing portion of an ink jet printer, in comparison with noise values when a conventional gear is used for the driving mechanism of the printing portion of the ink jet printer;

FIG. 6 is a table showing the noise values of FIG. 5 as numerical values;

FIGS. 7A through 7D are plan views showing a tooth of the second preferred embodiment of a gear according to the present invention, which shows modified examples of the tooth shown in FIG. 3;

FIG. 8 is a front view of the third preferred embodiment of a gear according to the present invention;

FIG. 9 is a sectional view taken along line IX-IX of FIG. 8;

FIG. 10A is an enlarged front view of part of the fourth preferred embodiment of a gear according to the present invention;

FIG. 10B is a sectional view taken along line XB-XB of FIG. 10A;

FIG. 10C is a sectional view taken along line XC-XC of FIG. 10A;

FIG. 11A is an enlarged front view of part of the fifth preferred embodiment of a gear according to the present invention;

FIG. 11B is a sectional view taken along line XIB-XIB of FIG. 11A;

FIG. 11C is a sectional view taken along line XIC-XIC of FIG. 11A;

FIG. 12A is an enlarged front view of part of the sixth preferred embodiment of a gear according to the present invention;

FIG. 12B is a sectional view taken along line XIIB-XIIB of FIG. 12A;

FIG. 12C is a sectional view taken along line XIIC-XIIC of FIG. 12A;

FIG. 13A is an enlarged perspective view of a first example of a conventional gear;

FIG. 13B is an enlarged front view of teeth of the gear of FIG. 13A;

FIG. 14A is an enlarged perspective view of teeth of a second example of a conventional gear;

FIG. 14B is a view showing a state that the gear of FIG. 14A meshes with another gear;

FIG. 15 is an enlarged perspective view of teeth of a third example of a conventional gear;

FIG. 16 is an enlarged perspective view of teeth of a fourth example of a conventional gear;

FIG. 17 is an enlarged perspective view of a tooth of a fifth example of a conventional gear;

FIG. 18 is an enlarged perspective view of a tooth of a sixth example of a conventional gear; and

FIG. 19 is an enlarged perspective view of teeth of a gear proposed by the inventors of the present application in order to eliminate problems in the first through sixth examples.

### DESCRIPTION OF THE PREFERRED EMBODIMENTS

Referring now to the accompanying drawings, the preferred embodiments of the present invention will be described below in detail.

### First Preferred Embodiment

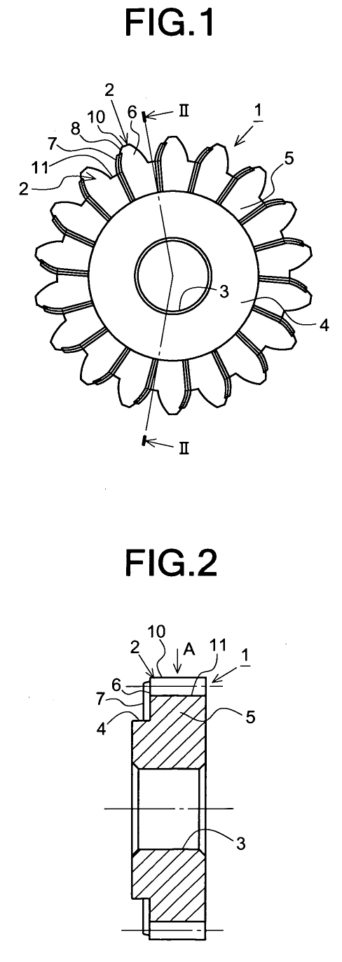

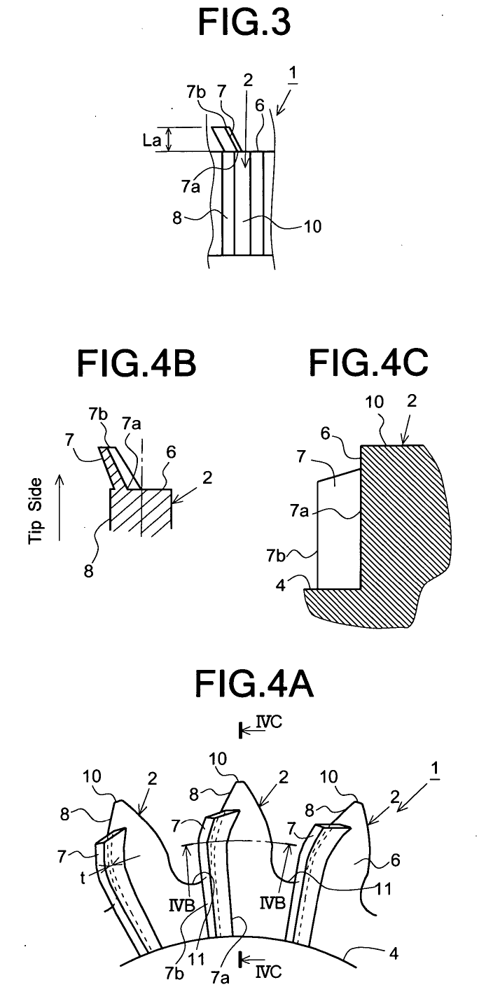

FIGS. 1 through 3 and FIGS. 4A through 4C show the first preferred embodiment of a gear 1 according to the present invention. FIG. 1 is a front view of the gear 1 in this preferred embodiment, and FIG. 2 is a sectional view of the gear 1 taken along line II-II of FIG. 1. FIG. 3 is a plan view of teeth 2 of the gear 1, which is viewed in a direction of arrow A of FIG. 2. FIGS. 4A through 4C are enlarged views of part of the teeth 2.

In these figures, for example, the gear 1 in this preferred embodiment is a spur gear which is formed by injection-molding a resin material, such as polyacetal, polyamide, polyphenylene sulfide or polybutylene terephthalate. The gear 1 has a plurality of teeth 2 on the outer periphery of a substantially disk-shaped web 5 which is formed on the outer periphery of a boss portion 4 having an axial hole 3. In this preferred embodiment, each of the teeth 2 has a high-tooth which has a higher contact ratio than that of a full depth tooth.

The gear 1 is formed so that a thin overhanging portion 7 protrudes from one end face 6 of each of the teeth 2 on the side that the boss portion 4 protrudes from the side face of the web 5 (on the left side in FIG. 2) and on the side of the one end face 6 in facewidth directions of each of the teeth 2. The overhanging portion 7 is an elastically deformable plate-shaped protruding piece. The root portion of the overhanging portion 7 (the connecting portion of the overhanging portion 7 to the one end face 6 of each of the teeth 2) is formed in a portion which is retracted from a tooth flank 8 by t mm (e.g., 0≦t≦0.1). Thus, if the overhanging portion 7 is elastically deformed by a tooth of a companion gear meshing with the gear 1, the contact portion of the overhanging portion 7 contacting the tooth of the meshing companion gear is easily displaced to have the same plane as that of the tooth flank 8. As a result, noises such as rubbing noises are not produced between the meshing companion gear and the overhanging portion 7, so that the gears can surely contact each other.

The end portion (upper end portion) of the overhanging portion 7 on the side of a tooth crest 10 is arranged so as to be retracted (spaced) from the tooth crest 10 toward a bottom land 11 by a predetermined amount, and the overhanging portion 7 is formed so as to substantially extend along the tooth flank 8. Thus, if the gear 1 is a driven gear, the overhanging portion 7 can smoothly contact a companion gear when each of the teeth 2 starts to mesh with the companion gear. If the gear 1 is a driving gear, the overhanging portion 7 can be smoothly disengaged from a companion gear when each of the teeth 2 is disengaged from the companion gear.

The inner end of the overhanging portion 7 in radial directions is connected to the outer peripheral surface of the boss portion (annular protruding portion) 4 which is arranged inside of the bottom land 11 in radial directions. Thus, the flow of a molten resin is improved during injection molding, so that the overhanging portion 7 can be precisely molded. As a result, it is possible to effectively prevent the deterioration in damping function due to the defective shape of the overhanging portion 7, and the production of noises due to the deterioration in damping function.

The overhanging portion 7 is obliquely formed so as to approach adjacent one of the teeth 2 as a distance from a root portion 7a toward a tip portion 7b increases, and the overhanging portion 7 is formed so that the tip portion 7b surely protrudes from one of the tooth flanks 8 toward the adjacent one of the teeth 2. Thus, when the gear 1 starts to mesh with a companion gear, the overhanging portion 7 gradually contacts the companion gear from the tip portion 7b to gradually apply an elastic deformation resistance. Therefore, each of the teeth 2 can smoothly mesh with the companion gear without applying sudden force, so that it is possible to prevent teeth knocking noises and vibration noises due to shocks when each of the teeth 2 meshes with the companion gear.

An example of dimension of the overhanging portion 7 will be described below in order to facilitate better understanding of the shape thereof. If the gear 1 has a module of about 0.5 to 2.0 mm, the thickness of the overhanging portion 7 is about 0.1 mm. The dimension La of the overhanging portion 7 protruding from the one end face 6 in facewidth directions is 0.5 mm, and the protruding dimension of the overhanging portion 7 protruding from one of the tooth flanks 8 is equal to or smaller than a backlash dimension (see FIG. 3 and FIGS. 4A through 4C). During transmission of rotation, the overhanging portion 7 is elastically deformed by one of the teeth of the companion gear meshing with the gear 1, to fulfill a damping function to allow a corresponding one of the teeth 2 to smoothly contact the one of the teeth of the companion gear. In this preferred embodiment, it is not always required that the overhanging portion 7 can remove backlash if the overhanging portion 7 can fulfill the damping function. The example of dimension of the overhanging portion 7 is only an example, and the present invention should not be limited thereto. The optimum dimension may be determined in accordance with conditions, such as the module of the teeth 2 and transmission torque.

This preferred embodiment is an embodiment wherein the gear 1 is formed by injection molding, so that the overhanging portion 7 and so forth have a draft. Therefore, the thickness of the overhanging portion 7 is slightly decreased by the draft as a distance from the root portion 7a toward the tip portion 7b increases, although the overhanging portion 7 has a substantially constant thickness.

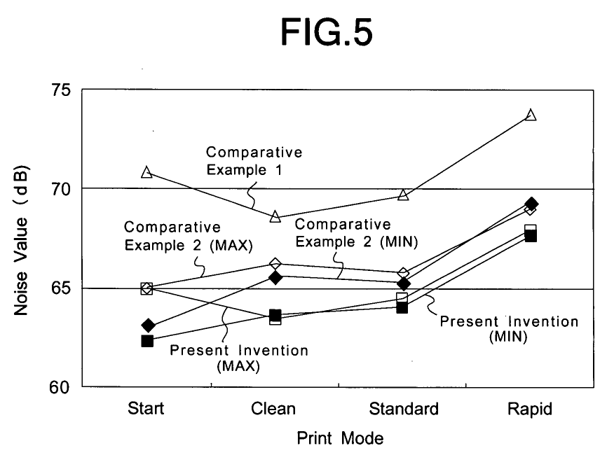

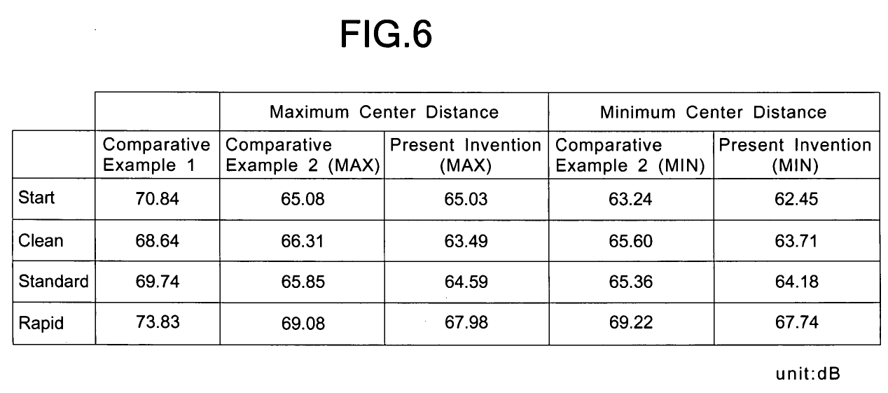

FIG. 5 shows noise values when a gear in this preferred embodiment is used for a driving mechanism of a printing portion of an ink jet printer, in comparison with noise values when a conventional gear is used for the driving mechanism of the printing portion of the ink jet printer. FIG. 6 is a table showing the noise values of FIG. 5 as numerical values.

In FIGS. 5 and 6, the gear in Comparative Example 1 is a typical brass gear with full depth teeth, which is conventionally used, and is designed to be meshed with a resin gear. The gear in Comparative Example 2 is a resin high-tooth gear which is used in place of the brass gear in Comparative Example 1. The gear according to the present invention is the gear 1 in this preferred embodiment, which is used in place of the brass gear in Comparative Example 1. In addition, with respect to the gear in Comparative Example 2 and the gear 1 according to the present invention, a case (shown by MAX in FIGS. 5 and 6) where the center distance between a pair of gears meshing with each other is maximum within allowance, and a case (shown by MIN in FIGS. 5 and 6) where the center distance is minimum within allowance are compared.

As shown in these figures, in Comparative Example 2 and the present invention as compared with Comparative Example 1, it is possible to reduce noise values in all of “start”, “clean” print mode, “standard” print mode and “rapid” print mode. In addition, in the case of MAX in the present invention as compared with MAX in Comparative Example 2, it is possible to reduce noise values in all of “start”, “clean” print mode, “standard” print mode and “rapid” print mode. Moreover, in the case of MIN according to the present invention as compared with MIN in Comparative Example 2, it is possible to reduce noise values in all of “start”, “clean” print mode, “standard” print mode and “rapid” print mode.

Furthermore, according to the present invention, noise values can be lower by about 5 to 8.4 decibels (dB) than those in Comparative Example 1. In addition, according to the present invention, in the case of MAX, noise values can be lower by about 0.05 to 2.82 (dB) than those in the case of MAX in Comparative Example 2. Moreover, according to the present invention, in the case of MIN, noise values can be lower by about 0.8 to 1.9 (dB) than those in the case of MIN in Comparative Example 2. According to the present invention as compared with Comparative Example 2, it is possible to reduce noises in any one of “clean”, “standard” and “rapid” print modes during forward rotation. According to the present invention, even if the gears are reversely rotated to clean the printing portion during a starting operation, noise values can be substantially equal to those in Comparative Example 2. According to the present invention, the variation in noise value between the maximum and minimum center distances (MAX and MIN) can be smaller than that in Comparative Example 2.

As described above, according to the gear 1 in this preferred embodiment, during transmission of rotation, the overhanging portion 7 can be pressed and reduced by one of the teeth of the meshing companion gear to be elastically deformed to suppress shocks when the gears mesh with each other, so that it is possible to inhibit the production of teeth knocking noises and vibrations to reduce operation noises.

In the gear 1 in this preferred embodiment, the overhanging portion 7 is the plate-shaped protruding piece which is easy to be elastically deformed and which prevents the contact pressure between the overhanging portion 7 and the tooth flank of the companion gear from being excessive. Therefore, the overhanging portion 7 has the stable damping function for a long period of time, so that it is possible to reduce operation noises for a long period of time to eliminate the problem in the first conventional example.

In the gear 1 in this preferred embodiment, the elastically deformable overhanging portion 7 is formed so as to protrude from the one end face 6 of each of the teeth 2, and is designed to be elastically deformed to have the same plane as that of the tooth flank 8 of a corresponding one of the teeth 2 during transmission of rotation. Therefore, it is possible to precisely transmit rotation by causing the tooth flanks of the rigid teeth to contact each other, so that it is possible to eliminate the problems in the second through fifth conventional examples.

In the gear 1 in this preferred embodiment, the overhanging portion 7 can sufficiently protrude from the one end face 6 in facewidth directions toward adjacent one of the teeth 2. Thus, when the teeth of the meshing companion gear move by backlash, the elastically deformable overhanging portion 7 can fulfill the damping function, so that it is possible to eliminate shocks when the teeth 2 contact each other. Therefore, in the gear 1 in this preferred embodiment, the protruding amount of the overhanging portion 7 protruding from one of the tooth flanks 8 can be greater than that in the sixth conventional example wherein part of the tooth flank 75 of each tooth 72 is caused to swell by the difference in shrinkage after injection molding, so that it is possible to more effectively fulfill the damping function.

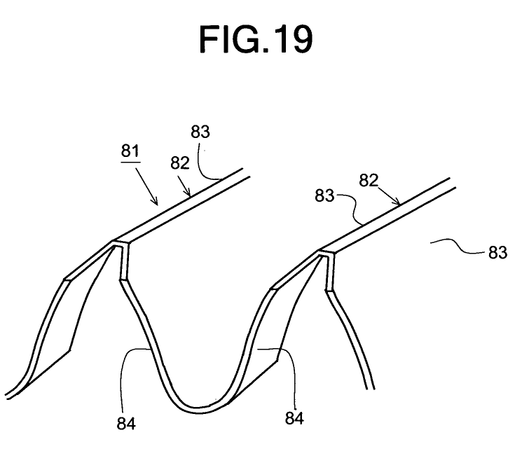

In the gear 1 in this preferred embodiment, each of the overhanging portions 7 is the plate-shaped protruding piece, and the overhanging portions 7 are separately elastically deformable. Therefore, it is possible to more smoothly vary the contact pressure between the teeth of the meshing companion gear and the overhanging portions 7 than that in the gear 81 wherein each of the overhanging portions 84 is continuously formed along the tooth flank 83 so as to be connected to the overhanging portion 84 of adjacent one of the teeth 82 (see FIG. 19). As a result, particularly in an ink jet printer designed to clean a printing head by reversely rotating the driving mechanism of a printing portion at a starting operation, the gear 1 in this preferred embodiment can reduce operation noises at the starting operation (by about 2 dB) in comparison with the gear 81, so that it is possible to more greatly reduce operation noises. In addition, the overhanging portions 7 of the gear 1 in this preferred embodiment are formed so as to fulfill a good damping function even if the center distance between gears meshing with each other varies within allowance. Therefore, it is possible to more effectively prevent the production of noises, such as rubbing noises, due to excessive contact pressure between the overhanging portions 7 and the companion gear, in comparison with the gear 81.

While the resin gear formed by injection molding has been described as an example in the above described preferred embodiment, the present invention should not be limited thereto, but the invention may be applied to a resin gear formed by hot/pressure forming using a die and to a resin gear formed by cutting work. Moreover, this preferred embodiment may be applied to a metal gear.

### Second Preferred Embodiment

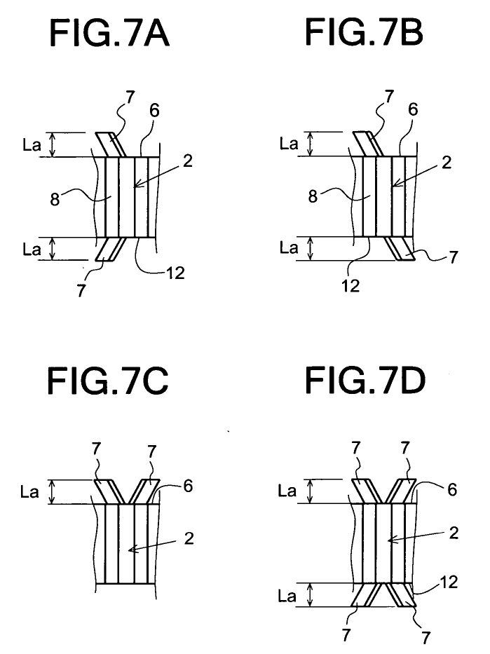

FIGS. 7A through 7D are plan views showing one of teeth 2 of the second preferred embodiment of a gear according to the present invention, which shows modified examples of one of the teeth 2 in the above described first preferred embodiment. In FIG. 7A, a pair of overhanging portions 7 are formed on both end faces 6 and 12 in facewidth directions of each of the teeth 2 so as to obliquely protrude toward adjacent one of the teeth 2 (to the left in the figure) from a portion near one of tooth flanks 8. In FIG. 7B, a pair of overhanging portions 7 are formed on both end faces 6 and 12 in facewidth directions of each of the teeth 2, one of the overhanging portions 7 being formed so as to obliquely protrude from one end face 6 to the left in the figure, and the other overhanging portion 7 being formed so as to obliquely protrude from the other end face 12 to the right in the figure. In FIG. 7C, a pair of overhanging portions 7 are formed on one end face 6 in facewidth directions, one of the overhanging portions 7 being formed so as to obliquely protrude from the one end face 6 to the left in the figure, and the other overhanging portion 7 being formed so as to obliquely protrude from the one end face 6 to the right in the figure. In FIG. 7D, a pair of overhanging portions 7, which are the same as the pair of overhanging portions 7 formed on one end face 6 shown in FIG. 7C, are also formed on the other end face 12. Thus, the overhanging portions 7 should not be limited to the embodiment shown in FIG. 3, and the position and number of the overhanging portions 7 may be suitably changed in view of the shape of the gear 1, the shape of a companion gear to mesh with the gear 1, and so forth.

### Third Preferred Embodiment

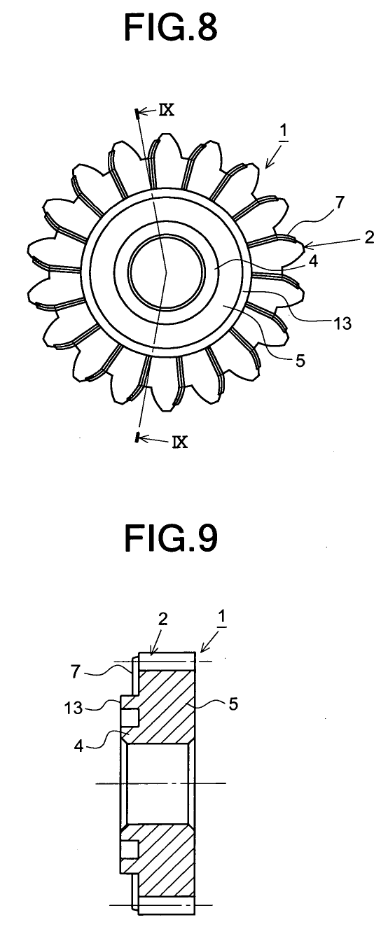

FIGS. 8 and 9 show the third preferred embodiment of a gear according to the present invention. This preferred embodiment may be applied to a gear 1 having a large outer diameter, and is suitably applied when the distance between a boss portion 4 and teeth 2 in radial directions is great. That is, in this preferred embodiment, a circumferential protrusion (annular protrusion) 13 is formed on the side face of a web 5 between the boss portion 4 and the teeth 2 so as to be substantially concentric with the pitch circle of the teeth 2, and the inner end of an overhanging portion 7 in radial directions is connected to the outer periphery of the circumferential protrusion 13. According to this embodiment, it is also possible to obtain the same advantageous effects as those of the gear 1 in the above described first preferred embodiment.

### Fourth Preferred Embodiment

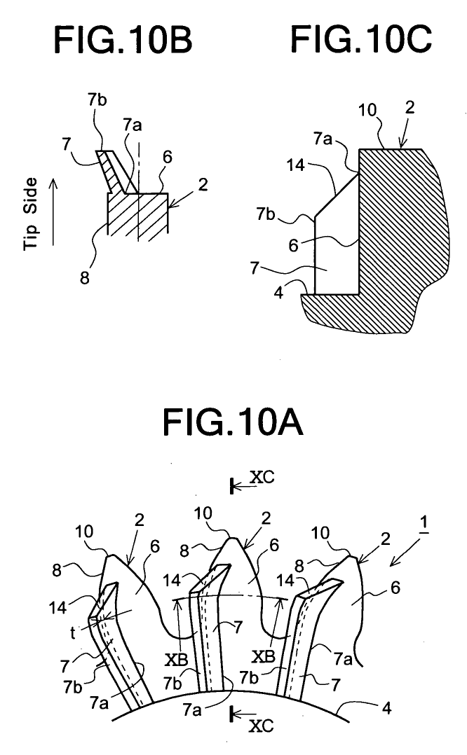

FIGS. 10A through 10C partially show teeth 2 of the fourth preferred embodiment of a gear 1 according to the present invention, which show a modified example of the gear 1 in the above described first preferred embodiment.

As shown in FIGS. 10A through 10C, a guide portion 14 which is more obliquely than a draft is formed so as to obliquely cut out from a root portion 7a toward a tip portion 7b. Thus, when the gear 1 in this preferred embodiment meshes with a companion gear, a corresponding one of the teeth of the companion gear is smoothly guided along the guide portion 14 of the overhanging portion 7 to a predetermined meshing position. As a result, when the gear 1 in this preferred embodiment meshes with the companion gear, the overhanging portion 7 is not damaged by the teeth of the companion gear.

### Fifth Preferred Embodiment

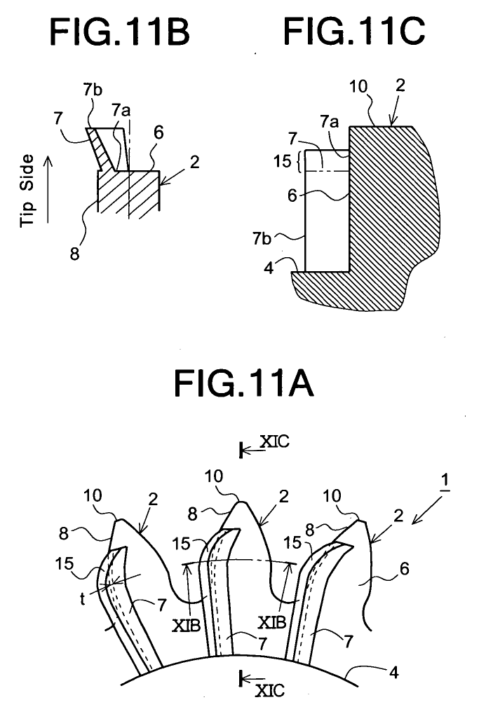

FIGS. 11A through 11C partially show teeth 2 of the fifth preferred embodiment of a gear 1 according to the present invention, which show another modified example of the gear 1 in the above described first preferred embodiment.

As shown in FIGS. 1A through 1C, in the gear 1 in this preferred embodiment, a guide portion 15 is formed so that the outer end portion of an overhanging portion 7 in radial directions is gradually curved from a tooth crest 10 toward a bottom land 11, and the protruding amount of the guide portion 15 protruding from one of tooth flanks 8 toward adjacent one of teeth 2 gradually increases in the form of a circular arc as a distance from the tooth crest 10 toward the bottom land 11 increases. As a result, the guide portion 15 of the gear 1 in this preferred embodiment has the same function as that of the guide portion 14 of the gear 1 in the above described fourth preferred embodiment, so that it is possible to obtain the same advantageous effects as those in the fourth preferred embodiment.

### Sixth Preferred Embodiment

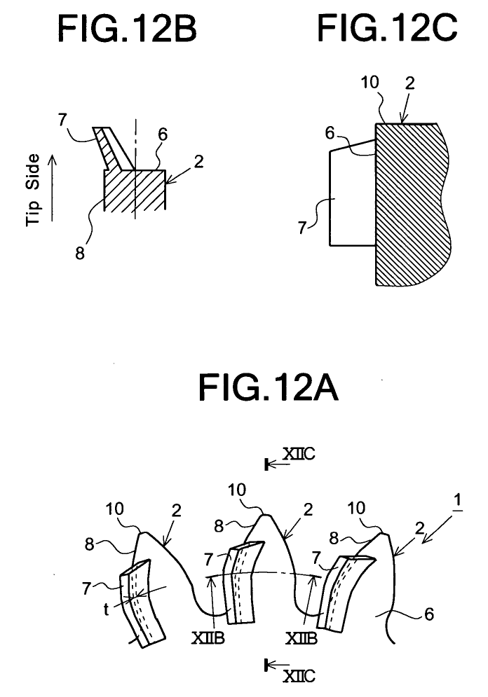

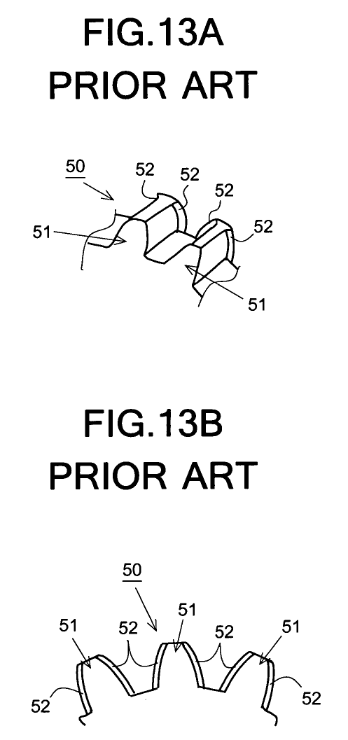

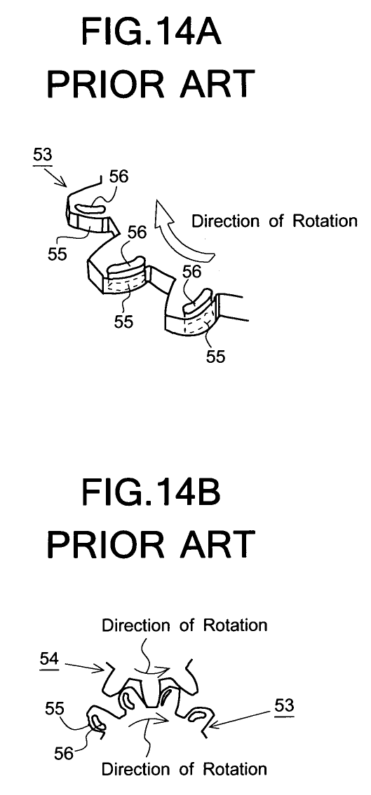

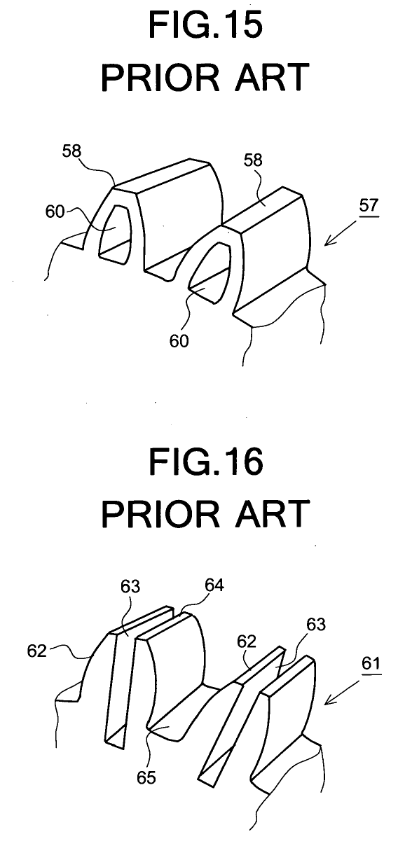

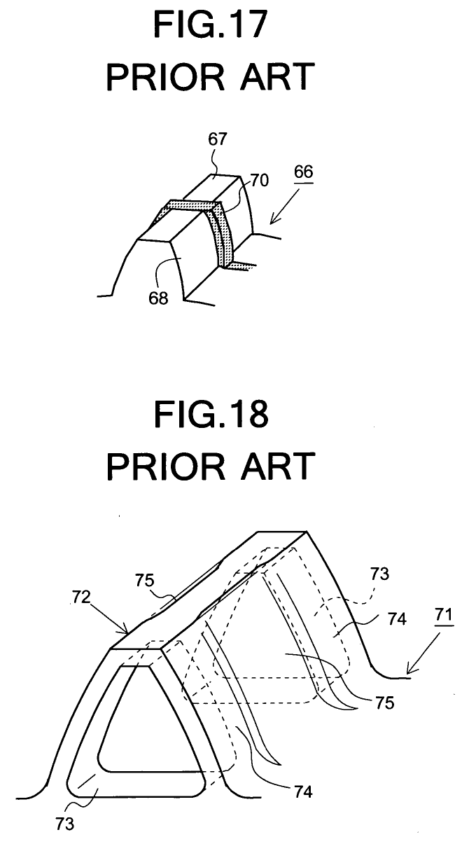

FIGS. 12A through 12C partially show teeth 2 of the sixth preferred embodiment of a gear 1 according to the present invention, which show another modified example of the gear 1 in the above described first preferred embodiment.

In the gear 1 in this preferred embodiment shown in FIGS. 12A through 12C, the inner portion of each of overhanging portions 7 in radial directions is cut out from the gear 1 shown in FIG. 1 to decrease the length of the overhanging portions 7, and the inner end of each of the overhanging portions 7 in radial directions is spaced from the outer periphery of the boss portion 4 shown in FIG. 1. As a result, the overhanging portions 7 of the gear 1 in this preferred embodiment are more easily elastically deformed than the overhanging portion 7 of the gear 1 of FIG. 1. However, since the inner end of each of the overhanging portions 7 in radial directions is not connected to the boss portion 4 in the gear 1 in this preferred embodiment, the flowability of a resin in the overhanging portions 7 during molding is not good, so that the precision of the shape of the overhanging portions 7 slightly deteriorates. Therefore, it is required to suitably choose one of the gear 1 of FIG. 1 and the gear 1 in this preferred embodiment in view of operating conditions so as to optimally reduce operation noises.

Since the inner end of each of the overhanging portions 7 in radial directions is arranged inside of the bottom land 11 in radial directions in the gear 1 in this preferred embodiment, it is possible to precisely transmit rotation without having a bad influence on the meshing of the teeth 2 during transmission of rotation even if the shape of the inner end of any one of the overhanging portions 7 in radial directions is defective and/or even if burrs are produced during injection molding.

In a gear according to the present invention, an overhanging portion can contact the tooth flank of a companion meshing with the gear during transmission of rotation to fulfill a damping function. Thus, it is possible to eliminate shocks when teeth contact each other, so that it is possible to suppress teeth knocking noises and noises due to vibrations. In addition, in the gear according to the present invention, the overhanging portion is pressed and elastically deformed by the teeth of the companion gear meshing with the gear during transmission of rotation, to be displaced so as to have the same plane as that of the tooth flank of a corresponding one of the teeth. Thus, it is possible to precisely transmit rotation by rigid teeth, so that the gear according to the present invention can be widely applied to a power transmission device which is required to precisely transmit rotation and which is required to quietly and smoothly transmit rotation. In particular, a gear according to the present invention can be effectively applied to an intermittent rotation transmission device which is designed to frequently repeat rotation and stopping and which is also designed to reversely rotate. Thus, a gear according to the present invention can be widely applied to a power transmission device for image forming devices, such as ink jet printers, precision electrical equipments, automotive parts, precision mechanical equipments and so forth.

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modification to the shown embodiments which can be embodied without departing from the principle of the invention as set forth in the appended claims.

1. A gear having teeth on an outer periphery thereof, wherein each of said teeth has an elastically deformable overhanging portion which is formed on at least one of end faces in facewidth directions of a corresponding one of said teeth so as to protrude from a portion near one of tooth flanks of said corresponding one of said teeth toward adjacent one of said teeth, and
wherein a portion of said overhanging portion contacting one of teeth of a companion gear is formed so as to have the same plane as that of the one of tooth flanks when said overhanging portion is pressed by the one of teeth of said companion gear to be elastically deformed.

2. A gear as set forth in claim 1, wherein said overhanging portion is a substantially plate-shaped protruding piece, and said overhanging portion has a root portion which is arranged on said one of end faces so as to be retracted from said one of tooth flanks, said overhanging portion substantially extending along said one of tooth flanks, and an inner end of said overhanging portion in radial directions being arranged inside of a bottom land of the corresponding one of said teeth in radial directions.

3. A gear as set forth in claim 2, wherein said inner end of said overhanging portion is connected to an annular protruding portion which is formed on said one of end faces.

4. A gear as set forth in claim 1, wherein an outer end of said overhanging portion in radial directions is arranged so as to be spaced by a predetermined distance from a tooth crest of the corresponding one of said teeth toward said bottom land.

5. A gear as set forth in claim 2, wherein said overhanging portion is formed so that an outer end of said overhanging portion in radial directions is inclined from said root portion toward a tip portion thereof.
